(19) United States
(12) Patent Application Publication
(10) Pub. No.: US 2018/0206470 A1
(43) Pub. Date: Jul. 26, 2018

(54) Ice Fishing Notification System

(71) Applicant: Kenneth Casavant, Crystal Lake, IL (US)

(72) Inventor: Kenneth Casavant, Crystal Lake, IL (US)

(21) Appl. No.: 15/412,527

(22) Filed: Jan. 23, 2017

(51) Int. Cl. A01K 97/12; A01K 97/01; G08B 3/10; G08B 5/36

(52) U.S. Cl. CPC A01K 97/125; G08B 5/36; G08B 3/10; A01K 97/01

(57) ABSTRACT

An ice fishing notification system includes an ice fishing tip up that may be positioned over a hole on a frozen body of water thereby facilitating the ice fishing tip up to catch fish. The ice fishing tip up has a plank and a flag that is hingedly coupled to the plank. The flag is selectively positioned in a triggered position. A remote unit is operationally coupled to the ice fishing tip up such that the remote unit detects when the ice fishing tip up is triggered by a fish. A base unit is remotely positioned with respect to the remote unit and the base unit is in electrical communication with the remote unit. The base unit generates an audible alert when the remote unit detects the flag is positioned in the triggered position thereby facilitating a fish to be removed from the ice fishing tip up.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to notification devices and more particularly pertains to a new notification device for remotely alerting a user that a fish has triggered an ice fishing tip up.

### BRIEF SUMMARY OF THE INVENTION

An embodiment of the disclosure meets the needs presented above by generally comprising an ice fishing tip up that may be positioned over a hole on a frozen body of water thereby facilitating the ice fishing tip up to catch fish. The ice fishing tip up has a plank and a flag that is hingedly coupled to the plank. The flag is selectively positioned in a triggered position. A remote unit is operationally coupled to the ice fishing tip up such that the remote unit detects when the ice fishing tip up is triggered by a fish. A base unit is remotely positioned with respect to the remote unit and the base unit is in electrical communication with the remote unit. The base unit generates an audible alert when the remote unit detects the flag is positioned in the triggered position thereby facilitating a fish to be removed from the ice fishing tip up.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of remote unit and a base unit of an ice fishing notification system according to an embodiment of the disclosure.

FIG. 2 is a top view of a remote unit of an embodiment of the disclosure.

FIG. 3 is a front view of remote unit and an ice fishing tip up of an embodiment of the disclosure.

FIG. 4 is a top view of base unit of an embodiment of the disclosure.

FIG. 5 is a perspective in-use view of remote unit and an ice fishing tip up of an embodiment of the disclosure.

FIG. 6 is a top view of remote unit and an ice fishing tip up of an embodiment of the disclosure.

FIG. 7 is a schematic view of an embodiment of the disclosure.

### DETAILED DESCRIPTION OF THE INVENTION

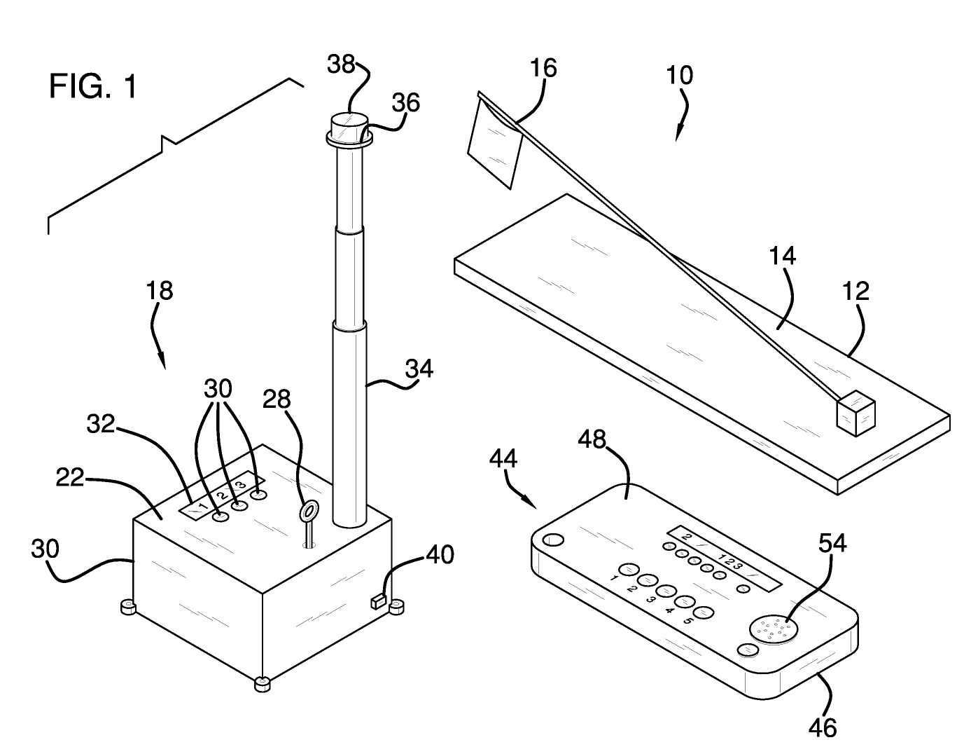

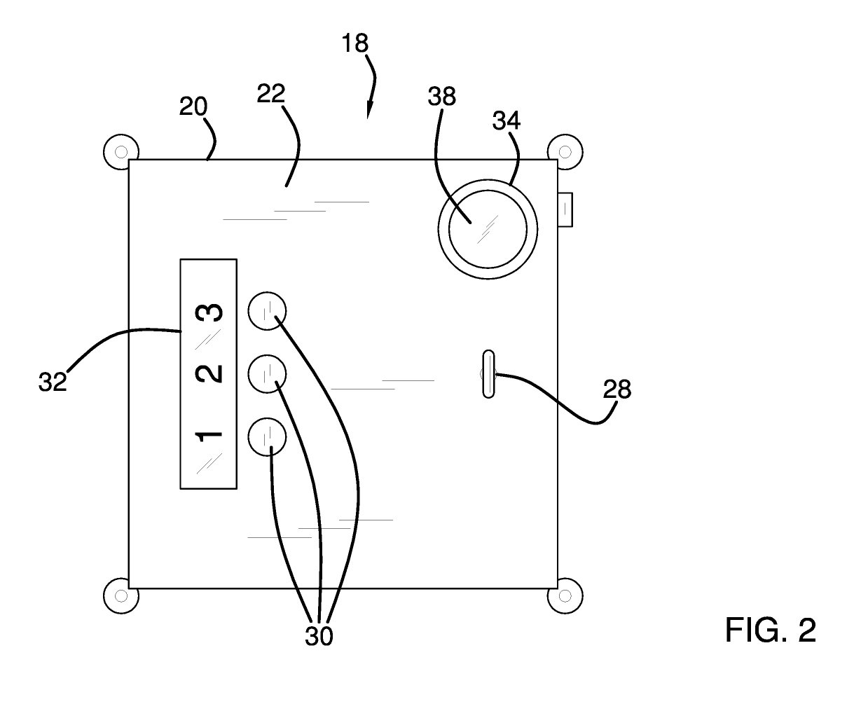

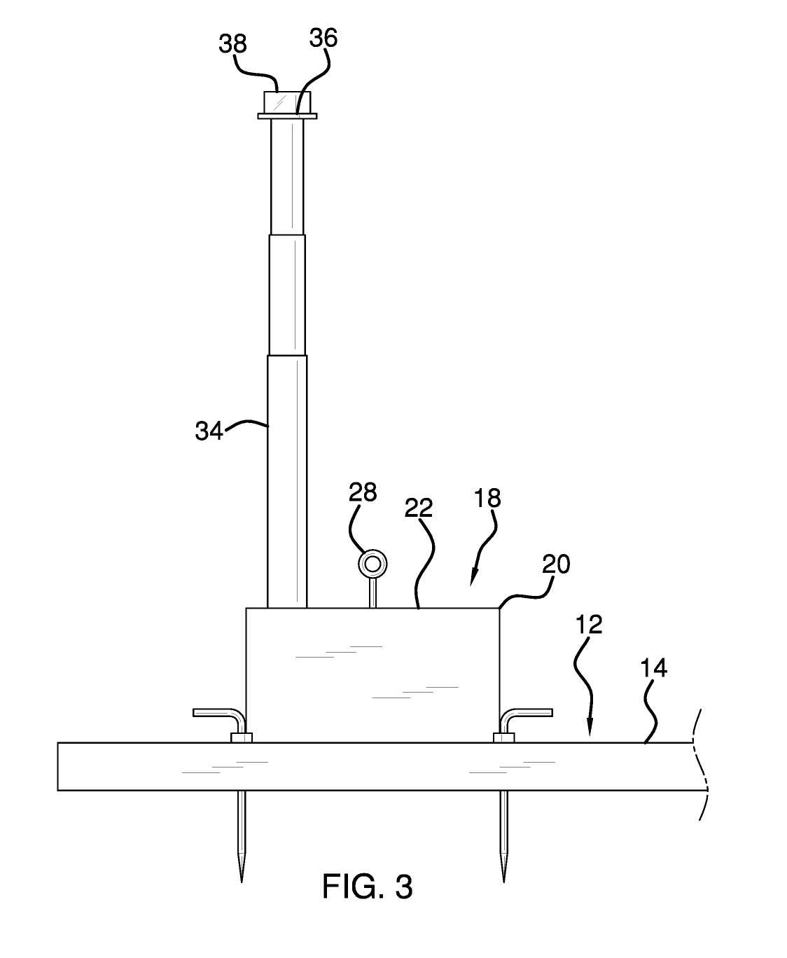

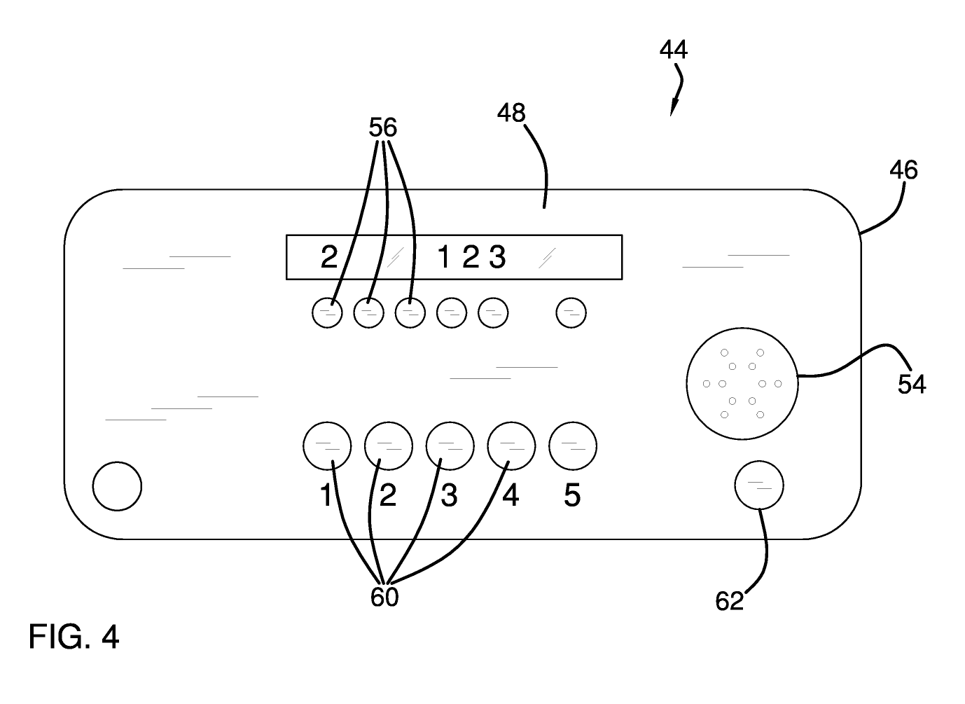

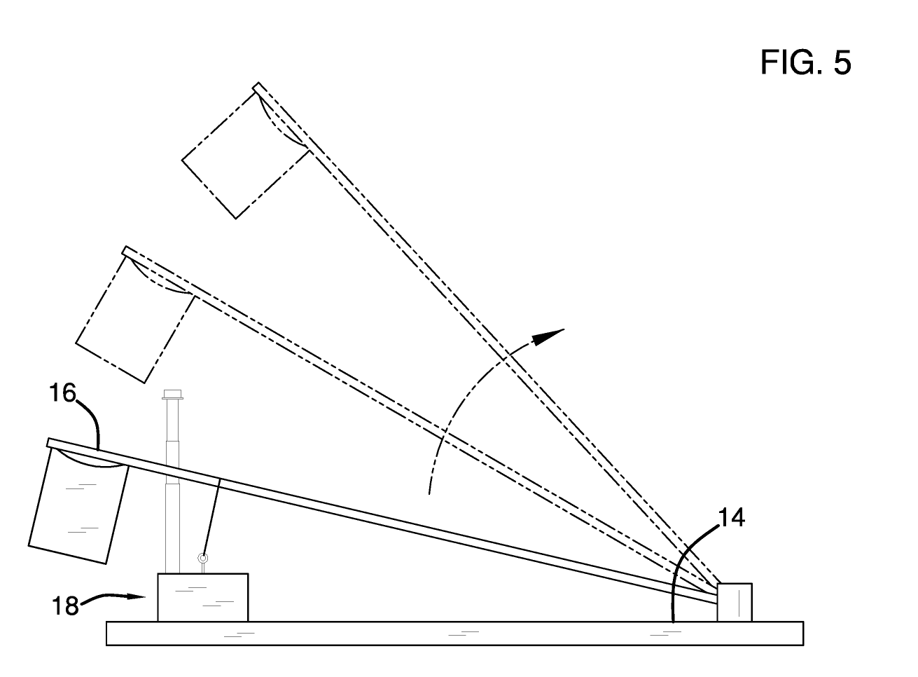

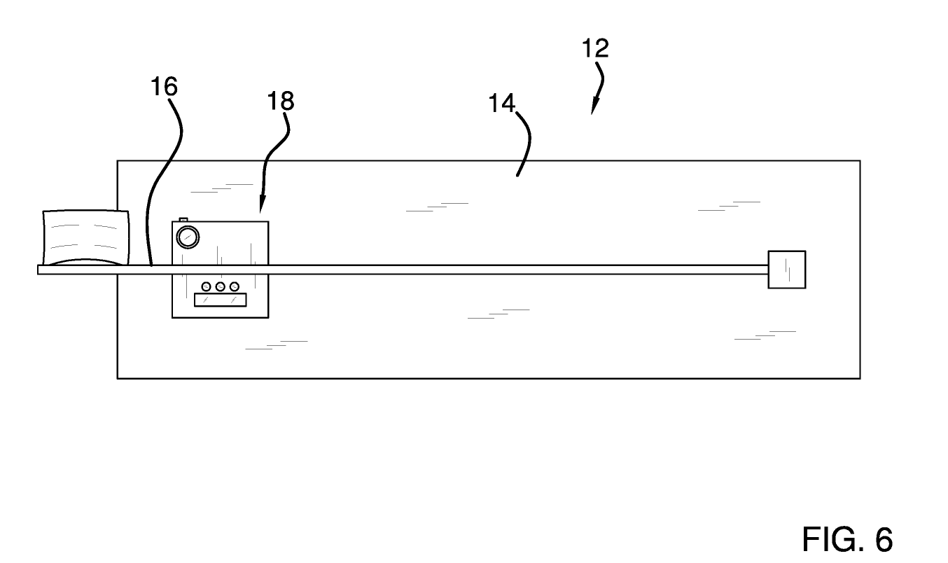

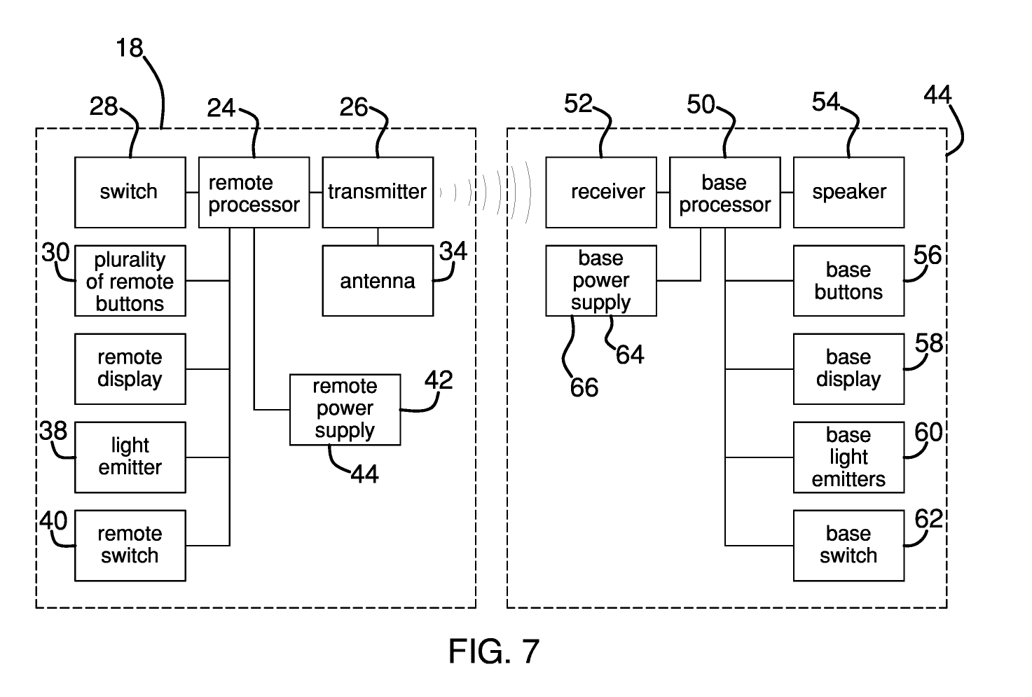

With reference now to the drawings, and in particular to FIGS. 1 through 7 thereof, a new notification device embodying the principles and concepts of an embodiment of the disclosure and generally designated by the reference numeral 10 will be described.

As best illustrated in FIGS. 1 through 7, the ice fishing notification system 10 generally comprises an ice fishing tip up 12 that is selectively positioned over a hole on a frozen body of water thereby facilitating the ice fishing tip up 12 to catch fish. The ice fishing tip up 12 has a plank 14 and a flag 16 that is hingedly coupled to the plank 14. Moreover, the flag 16 is selectively positioned in a triggered position. The ice fishing tip up 12 may be an ice fishing tip up of any conventional design.

A remote unit 18 is provided and the remote unit 18 is operationally coupled to the ice fishing tip up 12. The remote unit 18 detects when the ice fishing tip up 12 is triggered by a fish. The remote unit 18 comprises a remote housing 20 that is positioned on the plank 14 of the ice fishing tip up 12. The remote housing 20 has a top wall 22 and plurality of fasteners may extend through the remote housing 20 and engage the plank 14 thereby retaining the remote housing 20 on the plank 14.

A remote processor 24 is positioned within the remote housing 20 and the remote processor 24 selectively generates an alert sequence. The remote processor 24 may be an electronic processor or the like. A transmitter 26 is positioned within the remote housing 20 and the transmitter 26 is electrically coupled to the remote processor 24. The transmitter 26 has a plurality of transmission channels. Thus, the transmitter 26 communicates a trigger signal on a selected one of a plurality of predetermined transmission frequencies when the remote processor 24 generates the alert sequence. The transmitter 26 may be a radio frequency transmitter 26 or the like and the transmitter 26 may employ a WPAN signal. Additionally, the transmitter 26 may employ Bluetooth communication protocols.

A switch 28 is movably coupled to the remote housing 20 and the switch 28 extends upwardly through the top wall 22. The switch 28 is electrically coupled to the remote processor 24 and the switch 28 is coupled to the flag 16 on the ice fishing tip up 12. In this way the remote processor 24 generates the alert sequence when the flag 16 is positioned in the triggered position. A string may be coupled between the flag 16 and the switch 28. Moreover, the switch 28 may comprise a pin that extends upwardly through the top wall 22 of the remote housing 20 and the string may be tied to the pin.

A plurality of remote buttons 30 is provided and each of the remote buttons 30 is movably coupled to the top wall 22 of the remote housing 20. Each of the remote buttons 30 is selectively manipulated and each of the remote buttons 30 is electrically coupled to the transmitter 26 to select one of the transmission channels. A remote display 32 is coupled to the top wall 22 of the housing and the remote display 32 is electrically coupled to the remote processor 24. The remote display 32 indicates which of the transmission channels is selected and the remote display 32 may be an LDC display or the like.

An antenna 34 is coupled to and extends upwardly from the top wall 22 of the remote housing 20. The antenna 34 is electrically coupled to the transmitter 26 and the antenna 34 has a distal end 36 with respect to the remote housing 20. A light emitter 38 is coupled to the distal end 36 of the antenna 34 and the light emitter 38 emits light outwardly therefrom. The light emitter 38 is electrically coupled to the remote processor 24 and the light emitter 38 is turned on when the remote processor 24 generates the alert sequence. In this way the light emitter 38 facilitates the ice fishing tip up 12 to be located at night.

A remote switch 40 is coupled to the remote housing 20 and the remote switch 40 is selectively manipulated. The remote switch 40 is electrically coupled to the remote processor 24 such that the remote switch 40 turns the remote processor 24 on and off. A remote power supply 42 is positioned within the remote housing 20 and the remote power supply 42 is electrically coupled to the remote processor 24. The remote power supply 42 comprises at least one battery 44.

A plurality of the ice fishing tip ups 12 may be provided and a plurality of remote units 18 may be provided. Each of the plurality of remote units 18 may be attached to an associated one of the plurality of ice fishing tip ups 12. Additionally, the transmitter 26 corresponding to each of the plurality of remote units 18 may be actuated to transmit the alert sequence on a unique transmission channel with respect to each other.

A base unit 44 is remotely positioned with respect to the remote unit 18 and the base unit 44 is in electrical communication with the remote unit 18. The base unit 44 generates an audible alert when the remote unit 18 detects the flag 16 is positioned in the triggered position. In this way a fish may be removed from the ice fishing tip up 12 when the fish triggers the ice fishing tip up 12.

The base unit 44 comprises a base housing 46 that has an upper wall 48 and a base processor 50 that is positioned within the base housing 46. The base processor 50 selectively generates an alarm sequence and the base processor 50 may be an electronic processor or the like.

A receiver 52 is positioned within the base housing 46 and the receiver 52 is electrically coupled to the base processor 50. Moreover, the receiver 52 is in electrical communication with the transmitter 26. The base processor 50 generates the alarm sequence when the receiver 52 receives the alert sequence from the transmitter 26. The receiver 52 has a plurality of reception channels. The receiver 52 receives the trigger signal on a selected one of a plurality of predetermined reception frequencies when the remote processor 24 generates the alert sequence. In this way the base processor 50 differentiates between the plurality of remote units 18 when the plurality of remote units 18 is employed during ice fishing.

The receiver 52 may be a radio frequency receiver 52 or the like and the receiver 52 may employ a WPAN signal. Additionally, the receiver 52 may employ Bluetooth communication protocols. The receiver 52 is capable of receiving the trigger signal from each of the plurality of remote units 18 on a unique reception channel with respect to each other. In this way the receiver 52 may differentiate between the plurality of remote units 18 when the plurality of remote units 18 is employed during ice fishing.

A speaker 54 is coupled to the base housing 46 to emit audible sounds outwardly from the base housing 46. The speaker 54 is electrically coupled to the base processor 50 such that the speaker 54 emits an audible alarm when the base processor 50 generates the alarm sequence. In this way the speaker 54 alerts a user that a fish has triggered the ice fishing tip up 12.

A plurality of base buttons 56 is provided and each of the base buttons 56 is coupled to the upper wall 48 of the base housing 46. Each of the base buttons 56 is electrically coupled to the receiver 52 to select one of the reception channels. A base display 58 is coupled to the upper wall 48 of the base housing 46. The base display 58 is electrically coupled to the base processor 50 such that the base display 58 indicates which of the reception channels is selected. The base display 58 may be an LCD display or the like.

A plurality of base light emitters 60 is provided and each of the base light emitters 60 is coupled to the upper wall 48 of the base housing 46. Each of the base light emitters 60 selectively emits light outwardly from the base housing 46. Each of the base light emitters 60 is electrically coupled to the base processor 50 and a selected one of the base light emitters 60 is turned on when the base processor 50 generates the alarm sequence. In this way the selected base light emitter 38 communicates that the flag 16 has been positioned in the triggered position. The base processor 50 assigns each of the base light emitters 60 to an associated one of the plurality of remote units 18 when the plurality of remote units 18 is used. In this way the user is notified which of the plurality of ice fishing tip ups 12 has been triggered by the fish.

A base switch 62 is coupled to the base housing 46 and the base switch 62 may be manipulated. The base switch 62 is electrically coupled to the base processor 50 such that the base switch 62 turns the base processor 50 on and off. A base power supply 64 is positioned within the base housing 46 and the base power supply 64 is electrically coupled to the base processor 50. The base power supply 64 comprises at least one battery 66.

In use, the ice fishing tip up 12 is placed in a selected spot on the frozen body of water in the convention of ice fishing. The flag 16 is operationally coupled to the switch 28 on the remote unit 18. Each of the plurality of ice fishing tip ups 12 has an associated one of the plurality of remote unit 18s coupled thereto when the plurality of ice fishing tip ups 12 is used while ice fishing. The base unit 44 is carried with the user while the user is ice fishing. The remote processor 24 generates the alert sequence when the flag 16 is positioned in the triggered position by a fish. The transmitter 26 transmits the trigger signal on the selected transmission channel and the receiver 52 receivers the trigger signal on the selected reception channel. The base processor 50 generates the alarm sequence when the receiver 52 receives the trigger signal from the transmitter 26. The speaker 54 emits the audible alarm and the base light emitter 38 that has been assigned to the corresponding remote unit 18 illuminates. In this way the user is notified that a fish has triggered the ice fishing tip up 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An ice fishing notification system comprising:
an ice fishing tip up being configured to be positioned over a hole on a frozen body of water thereby facilitating said ice fishing tip up to catch fish, said ice fishing tip up having a plank and a flag being hingedly coupled to said plank, said flag being selectively positioned in a triggered position;
a remote unit being operationally coupled to said ice fishing tip up such that said remote unit detects when said ice fishing tip up is triggered by a fish; and
a base unit being remotely positioned with respect to said remote unit, said base unit being in electrical communication with said remote unit, said base unit generating an audible alert when said remote unit detects said flag is positioned in said triggered position thereby facilitating a fish to be removed from said ice fishing tip up.

2. The assembly according to claim 1, wherein said remote unit comprises:
a remote housing being positioned on said plank of said ice fishing tip up, said remote housing having a top wall; and
a remote processor being positioned within said remote housing, said remote processor selectively generating an alert sequence.

3. The assembly according to claim 2, further comprising a transmitter being positioned within said remote housing, said transmitter being electrically coupled to said remote processor, said transmitter having a plurality of transmission channels such that said transmitter communicates a trigger signal on a selected one of a plurality of predetermined transmission frequencies when said remote processor generates said alert sequence.

4. The assembly according to claim 2, further comprising a switch being movably coupled to said remote housing, said switch extending upwardly through said top wall, said switch being electrically coupled to said remote processor, said switch being coupled to said flag on said ice fishing tip up such that said remote processor generates said alert sequence when said flag is positioned in said triggered position.

5. The assembly according to claim 3, further comprising a plurality of remote buttons, each of said remote buttons being movably coupled to said top wall of said remote housing wherein each of said remote buttons is configured to be manipulated, each of said remote buttons being electrically coupled to said transmitter to select one of said transmission channels.

6. The assembly according to claim 3, further comprising a remote display being coupled to said top wall of said housing, said remote display being electrically coupled to said remoter processor such that said remote display indicates which of said transmission channels is selected.

7. The assembly according to claim 3, further comprising an antenna being coupled to and extending upwardly from said top wall of said remote housing, said antenna being electrically coupled to said transmitter, said antenna having a distal end with respect to said remote housing.

8. The assembly according to claim 7, further comprising a light emitter being coupled to said distal end of said antenna wherein said light emitter is configured to emit light outwardly therefrom, said light emitter being electrically coupled to said remote processor, said light emitter being turned on when said remote processor generates said alert sequence.

9. The assembly according to claim 2, further comprising a remote switch being coupled to said remote housing wherein said remote switch is configured to be manipulated, said remote switch being electrically coupled to said remote processor such that said remote switch turns said remote processor on and off.

10. The assembly according to claim 2, further comprising a remote power supply being positioned within said remote housing, said remote power supply being electrically coupled to said remote processor, said remote power supply comprising at least one battery.

11. The assembly according to claim 1, wherein said base unit comprises:
a base housing having an upper wall; and
a base processor being positioned within said base housing, said base processor selectively generating an alarm sequence.

12. The assembly according to claim 11, further comprising:
a remote processor selectively generating an alert sequence;
a transmitter selectively transmitting said alert sequence; and
a receiver being positioned within said base housing, said receiver being electrically coupled to said base processor, said receiver being in electrical communication with said transmitter, said base processor generating said alarm sequence when said receiver receives said alert sequence from said transmitter, said receiver having a plurality of reception channels such that said receiver receives said trigger signal on a selected one of a plurality of predetermined reception frequencies when said remote processor generates said alert sequence.

13. The assembly according to claim 11, further comprising a speaker being coupled to said base housing wherein said speaker is configured to emit audible sounds outwardly from said base housing, said speaker being electrically coupled to said base processor such that said speaker emits an audible alarm when said base processor generates said alarm sequence wherein said speaker is configured to alert that a fish has triggered said ice fishing tip up.

14. The assembly according to claim 12, further comprising a plurality of base buttons, each of said base buttons being coupled to said upper wall of said base housing wherein each of said base buttons is configured to be manipulated, each of said base buttons being electrically coupled to said receiver to select one of said reception channels.

15. The assembly according to claim 12, further comprising a base display being coupled to said upper wall of said base housing, said base display being electrically coupled to said base processor such that said base display indicates which of said reception channels is selected.

16. The assembly according to claim 11, further comprising a plurality of base light emitters, each of said base light emitters being coupled to said upper wall of said base housing wherein each of said base light emitters is configured to selectively emit light outwardly from said base housing, each of said base light emitters being electrically coupled to said base processor, a selected one of said base light emitters being turned on when said base processor generates said alarm sequence such that said selected base light emitter communicates that said flag has been positioned in said triggered position.

17. The assembly according to claim 11, further comprising a base switch being coupled to said base housing wherein said base switch is configured to be manipulated, said base switch being electrically coupled to said base processor such that said base switch turns said base processor on and off.

18. The assembly according to claim 11, further comprising a base power supply being positioned within said base housing, said base power supply being electrically coupled to said base processor, said base power comprising at least one battery.

19. An ice fishing notification system comprising:
an ice fishing tip up being configured to be positioned over a hole on a frozen body of water thereby facilitating said ice fishing tip up to catch fish, said ice fishing tip up having a plank and a flag being hingedly coupled to said plank, said flag being selectively positioned in a triggered position;
a remote unit being operationally coupled to said ice fishing tip up such that said remote unit detects when said ice fishing tip up is triggered by a fish, said remote unit comprising:
a remote housing being positioned on said plank of said ice fishing tip up, said remote housing having a top wall,
a remote processor being positioned within said remote housing, said remote processor selectively generating an alert sequence,
a transmitter being positioned within said remote housing, said transmitter being electrically coupled to said remote processor, said transmitter having a plurality of transmission channels such that said transmitter communicates a trigger signal on a selected one of a plurality of predetermined transmission frequencies when said remote processor generates said alert sequence,
a switch being movably coupled to said remote housing, said switch extending upwardly through said top wall, said switch being electrically coupled to said remote processor, said switch being coupled to said flag on said ice fishing tip up such that said processor generates said alert sequence when said flag is positioned in said triggered position,
a plurality of remote buttons, each of said remote buttons being movably coupled to said top wall of said remote housing wherein each of said remote buttons is configured to be manipulated, each of said remote buttons being electrically coupled to said transmitter to select one of said transmission channels,
a remote display being coupled to said top wall of said housing, said remote display being electrically coupled to said remoter processor such that said remote display indicates which of said transmission channels is selected,
an antenna being coupled to and extending upwardly from said top wall of said remote housing, said antenna being electrically coupled to said transmitter, said antenna having a distal end with respect to said remote housing,
a light emitter being coupled to said distal end of said antenna wherein said light emitter is configured to emit light outwardly therefrom, said light emitter being electrically coupled to said remote processor, said light emitter being turned on when said remote processor generates said alert sequence,
a remote switch being coupled to said remote housing wherein said remote switch is configured to be manipulated, said remote switch being electrically coupled to said remote processor such that said remote switch turns said remote processor on and off, and
a remote power supply being positioned within said remote housing, said remote power supply being electrically coupled to said remote processor, said remote power supply comprising at least one battery; and
a base unit being remotely positioned with respect to said remote unit, said base unit being in electrical communication with said remote unit, said base unit generating an audible alert when said remote unit detects said flag is positioned in said triggered position thereby facilitating a fish to be removed from said ice fishing tip up, said base unit comprising:
a base housing having an upper wall,
a base processor being positioned within said base housing, said base processor selectively generating an alarm sequence,
a receiver being positioned within said base housing, said receiver being electrically coupled to said base processor, said receiver being in electrical communication with said transmitter, said base processor generating said alarm sequence when said receiver receives said alert sequence from said transmitter, said receiver having a plurality of reception channels such that said receiver receives said trigger signal on a selected one of a plurality of predetermined reception frequencies when said remote processor generates said alert sequence,
a speaker being coupled to said base housing wherein said speaker is configured to emit audible sounds outwardly from said base housing, said speaker being electrically coupled to said base processor such that said speaker emits an audible alarm when said base processor generates said alarm sequence wherein said speaker is configured to alert that a fish has triggered said ice fishing tip up,
a plurality of base buttons, each of said base buttons being coupled to said upper wall of said base housing wherein each of said base buttons is configured to be manipulated, each of said base buttons being electrically coupled to said receiver to select one of said reception channels,
a base display being coupled to said upper wall of said base housing, said base display being electrically coupled to said base processor such that said base display indicates which of said reception channels is selected,
a plurality of base light emitters, each of said base light emitters being coupled to said upper wall of said base housing wherein each of said base light emitters is configured to selectively emit light outwardly from said base housing, each of said base light emitters being electrically coupled to said base processor, a selected one of said base light emitters being turned on when said base processor generates said alarm sequence such that said selected base light emitter communicates that said flag has been positioned in said triggered position,
a base switch being coupled to said base housing wherein said base switch is configured to be manipulated, said base switch being electrically coupled to said base processor such that said base switch turns said base processor on and off, and
a base power supply being positioned within said base housing, said base power supply being electrically coupled to said base processor, said base power comprising at least one battery.
